(19) United States
(12) Patent Application Publication
(10) Pub. No.: US 2022/0145617 A1
(43) Pub. Date: May 12, 2022

(54) Corrugated Intumescent Composite Structure and a Method of Use

(71) Applicant: 3M INNOVATIVE PROPERTIES COMPANY, St. Paul, MN (US)

(72) Inventors: Jiangdong Tong, Ontario (CA); Utsav Dogra, Ontario (CA); Elise Lariviere, Ontario (CA); Victor K. Oreskovich, St. Paul Park, MN (US); Nicholas Vreugdenhil, Ontario (CA)

(21) Appl. No.: 17/435,121

(22) PCT Filed: Mar. 23, 2020
(86) PCT No.: PCT/IB2020/052680

§ 371 Date: Aug. 31, 2021

Related U.S. Application Data
(60) Provisional application No. 62/829,808, filed on Apr. 5, 2019.

(51) Int. Cl. E04B 1/94; C09D 5/18

(52) U.S. Cl. CPC E04B 1/942; C09D 5/185; E04B 1/944

(57) ABSTRACT

Described herein is a corrugated intumescent composite structure comprising at least one metal mesh layer secured on or in an intumescent material, wherein the composite structure comprises a plurality of alternating flanges and ribs. In one embodiment, the corrugated intumescent composite structure disposed onto a metal decking for fire protection.

### TECHNICAL FIELD

A corrugated intumescent composite structure is described along with its use as a protectant for metal decking under fire exposure.

### SUMMARY

Metal decking is used to support concrete floors and roofs in modern building construction. An important part of building design is the protection of the metal decking from the damaging effects of fire. For example, steel does not burn, but can lose strength at high temperatures. As a result, a variety of fire protection systems, namely mineral insulants, cementitious sprays and intumescent coatings, have been developed to insulate the steel from the effects of fire in order to prolong the time required for the steel to reach a temperature of about 538° C., generally by one to two hours, depending upon local fire regulations. However, these fire protection systems can require sophisticated installation equipment, require thick coatings, pretreatment of the building surface before application, and/or may be unable to be applied in adverse weather conditions such as rain or cold.

Thus, there is a desire to identify alternative intumescent materials for fire protection of building components, such as metal decking. These new materials should be easy to use, for example easy to install, and/or no need to prepare the building component prior to installation; be able to be installed under a variety of weather conditions; and be relatively thin (allowing for reduced cost of materials and occupying less real estate in the building).

In one aspect, a corrugated intumescent composite structure is disclosed. The composite structure comprising at least one metal mesh layer secured on or in an intumescent material, wherein the composite structure comprises a plurality of alternating flanges and ribs.

In another aspect, a method of protecting corrugated metal decking is disclosed. The method comprising attaching a corrugated intumescent composite structure to the corrugated metal decking, wherein the corrugated composite structure comprises at least one metal mesh layer secured on or in an intumescent material, and wherein both the corrugated composite structure and the corrugated metal decking comprises a plurality of alternating flanges and ribs.

In one embodiment of the method, at least one of the plurality of ribs of the corrugated metal decking is fastened to at least one of the plurality of flanges of the composite structure.

The above summary is not intended to describe each embodiment. The details of one or more embodiments of the invention are also set forth in the description below. Other features, objects, and advantages will be apparent from the description and from the claims.

### BRIEF DESCRIPTION OF DRAWINGS

For clearer understanding, preferred embodiments will now be described in detail by way of example, with reference to the accompanying drawings, in which:

FIGS. 1A and 1B are cross sectional views of exemplary embodiments of an intumescent composite material;

FIG. 2 is a cross sectional view of an exemplary embodiment of a corrugated intumescent composite structure of the present disclosure;

FIGS. 3A-3G are cross sectional views of exemplary embodiments of a corrugated intumescent composite structure of the present disclosure;

FIGS. 4A and 4B are cross sectional views of exemplary embodiments of a corrugated metal decking;

FIG. 5A is a cross sectional view of an exemplary mounting arrangement of a corrugated metal decking disposed on a corrugated intumescent composite structure of the present disclosure;

FIG. 5B is top view of an exemplary mounting arrangement of a corrugated metal decking disposed on a corrugated intumescent composite structure of the present disclosure; and

FIG. 6 is perspective view of an alternative mounting arrangement of a corrugated metal decking disposed on a corrugated intumescent composite structure of the present disclosure.

### DETAILED DESCRIPTION

As used herein, the term “a”, “an”, and “the” are used interchangeably and mean one or more; “and/or” is used to indicate one or both stated cases may occur, for example A and/or B includes, (A and B) and (A or B); and (meth) used in front of a word such as acrylate or acrylic refers to either the methylated or nonmethylated form, for example, (meth)acrylate refers to acrylate and/or methacrylate.

Also herein, recitation of ranges by endpoints includes all numbers subsumed within that range (e.g., 1 to 10 includes 1.4, 1.9, 2.33, 5.75, 9.98, etc.).

Also herein, recitation of “at least one” includes all numbers of one and greater (e.g., at least 2, at least 4, at least 6, at least 8, at least 10, at least 25, at least 50, at least 100, etc.).

The present disclosure is directed to a corrugated intumescent composite material. In one embodiment, this corrugated intumescent composite material can be used to protect metal decking in case of a fire.

Corrugated Intumescent Composite Structure

The corrugated intumescent composite material of the present disclosure comprises a metal mesh layer, which is secured on or in an intumescent material. This intumescent composite material is corrugated.

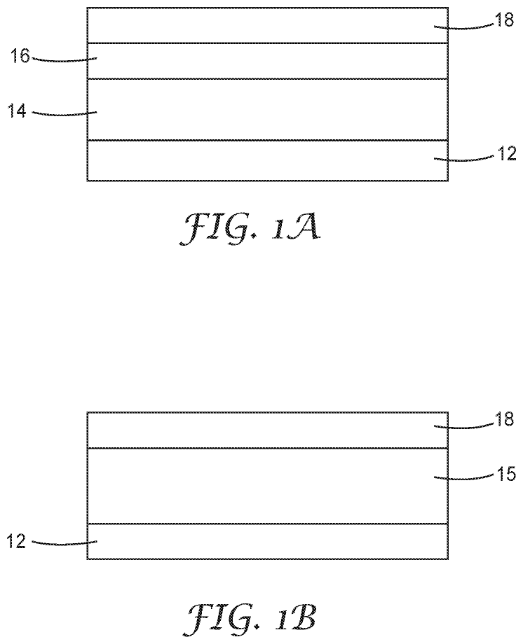

FIGS. 1A and 1B depict two different embodiments of an intumescent composite material. FIG. 1A is a multi-layered intumescent composite material, comprising optional polymeric layer 18 disposed on intumescent layer 16, which is disposed on metal mesh layer 14, which is disposed on optional liner 12. FIG. 1B is a multi-layered intumescent composite material, comprising optional polymeric layer 18 disposed on layer 15, which comprises intumescent material in a metal mesh layer, which is disposed on optional liner 12.

Intumescent materials are materials that when exposed to heat or flames, expand in volume in a controlled manner typically at exposure temperatures above about 150° C. or even above about 200° C., producing an insulating and ablative char, which serves as a barrier to heat, smoke, and flames. The intumescent materials of the present disclosure comprise an expanding component, a binder, and optional fillers and additives. The expanding component is an expanding inorganic component, an expanding organic component, or combinations thereof.

The expanding inorganic component includes those known in the art. including silicates, for example those based on alkali silicates such as sodium silicate, potassium silicate, magnesium silicate and lithium-sodium-potassium silicate; expandable graphite; and vermiculite.

The expanding organic component is known in the art and may comprise one or more of a charring catalyst (i.e., acid donor), charring agent (i.e., carbonific char former) and blowing agent (i.e., spumific). Preferably, at least the charring catalyst and charring agent are utilized in the intumescent organic component. Any suitable charring catalyst or mixture thereof may be employed. The charring catalyst is an acid donor and may comprise, for example, phosphate-based or non-phosphate-based catalysts. One or more phosphate-based charring catalysts are preferred, for example ammonium polyphosphate, alkyl phosphates, haloalkyl phosphates, melamine phosphate, products of reaction of urea or guanidyl urea with phosphoric acids or product of reaction of ammonia with P₂O₅. The charring catalyst is preferably present in the intumescent material in an amount of about 25-55 wt %, more preferably about 30-50 wt % or about 35-45 wt %, based on total weight of the intumescent material. Any suitable charring agent or mixture thereof may be employed, for example polyhydric alcohols (e.g., starch, dextrin, pentaerythritol (monomer, dimer, trimer, polymer), phenol-formaldehyde resins or methylol melamine). Pentaerythritol and di-pentaerythritol are preferred. The charring agent is preferably present in the intumescent material in an amount of about 5-20 wt %, more preferably about 8-15 wt %, based on total weight of the intumescent material. When a blowing agent is used, any suitable blowing agent or mixture thereof may be employed, for example amines or amides (e.g., urea, urea-formaldehyde resins, dicyandiamide, melamine or polyamides). Melamine is preferred. The blowing agent is preferably present in the intumescent material in an amount of about 5-20 wt %, more preferably about 8-15 wt %, based on total weight of the intumescent material. When this expanding organic component is subjected to heat, a series of reactions occur. For example, the ammonium polyphosphate decomposes to produce polyphosphoric acid, catalyzing the dehydration of pentaerythritol to produce char. The blowing agent also starts to decompose, giving off non-flammable gases that cause the carbon char to foam, thus producing a meringue-like structure that is highly effective in insulating the substrate from heat.

The intumescent materials of the present disclosure comprise a binder. The basic function of the binder is to bind together the components of the intumescent material. The binder may be a thermoplastic, an elastomer, a thermoset, or combinations thereof. In the case of a thermoplastic binder, in one embodiment, the binder can contribute to the formation of a uniform cellular foam structure, since the molten binder helps trap the gases given off by the decomposing blowing agents, thus ensuring a controlled expansion of the char.

The binder may comprise one or more polymers. The one or more polymers may be homopolymeric, copolymeric (including block copolymeric), terpolymeric or any blend thereof. Exemplary polymers include urethane, silicone, acrylic, methacrylic, epoxy, or other types of curable binder, polyesters, polyolefins, phenolics, vinyl acetate-based polymers, (meth)acrylate-based polymers and styrenic polymers.

In one embodiment, the binder is a thermoplastic elastomer comprising ethylene-vinyl acetate copolymers and/or styrene (meth)acrylic copolymers. In one embodiment, the binder is ethylene-vinyl acetate (EVA) copolymers having high vinyl acetate content. For example, polymers having a vinyl acetate content of the EVA of at least 20, 30, 40, or even 42 wt % based on the total weight of the polymer; and at most 70, 80, or even 90 wt % based on total weight of the polymer. Commercially available binders include those available under the trade designation “LEVAMELT” and/or “LEVAPREN” (both from Lanxess, Dormegen, Germany), which are ethylene-vinyl acetate copolymers having high vinyl acetate content, very low crystallinity and a very low glass transition temperature.

In one embodiment, the binder is present in the intumescent material in an amount of at least 15, 17, or even 20 wt %; and at most 25, 28, or even 30 wt % based on total weight of the intumescent material. Too much binder may lead to too much smoking and flaming when the intumescent material is activated. Not enough binder may cause flaking or loss of the intumescent material either during or following corrugation. Furthermore, the binder content of the intumescent material may be important to balance the ability of the intumescent material to hold the metal mesh and to permit the material to exude through the openings in the meshes when the material is intumescing.

In one embodiment, the intumescent material comprises expandable graphite, binder, and optional additives and/or fillers. In one embodiment, the intumescent material comprises at least 5, 10, 15, 20, 25, 30, 40, 50, 60, 70, 80, or even 90% by weight of expanding graphite.

The intumescent material may comprise other components suitable for fire protection applications such as an inorganic filler. Inorganic fillers include, for example, metal oxides (e.g., titanium dioxide, silicon dioxide), metal carbonates (e.g., calcium carbonate), metal or mixed metal silicates (e.g., clays, talc, mica, kaolin) and mixtures thereof. The inorganic filler may be present in the intumescent material in any suitable amount, for example about 5-25 wt %, or about 10-20 wt %, based on the total weight of the intumescent material.

In one embodiment, the intumescent material comprises an expanding organic component as well as a metal or mixed metal silicate.

In one embodiment, the intumescent material comprises a plasticizer. For example, a plasticizer may be added to adjust the glass transition temperature of the intumescent material easing product manufacture. Suitable plasticizers include, for example, dibutyl sebacate, dioctyl sebacate, dioctyl adipate, dibutyl adipate, blends of diethyl glycol benzoate, dipropylene glycol dibenzoate, trioctyl trimellitate, adepic polyester and alkyl sulphonate of phenol. Some alkyl phosphate based liquid flame retardants can also be used as plasticizers, for example tricresyl phosphate, tri(2-ethyl hexyl phosphate) and 2-ethyl hexyl diphenylphostate. The amount of plasticizer used is preferably no more than 5, 8 or even 10 wt % based on the total weight of the intumescent material. The combined amount of binder and plasticizer in the intumescent material is preferably at least 15, 17, or even 20 wt %; and at most 25, 30, 35, or even 40 wt % based on the weight of the intumescent material. The amount and type of plasticizer used should be chosen to enable ease of manufacture, while not diminishing the performance of the intumescent material.

For example, adding too much plasticizer may lower the intumescent material's physical properties, such as modulus, tensile strength, and hardness, to undesirable levels, potentially melting during fire conditions. Certain plasticizers may have a T_{g} (or Tₘ) higher than that of the binder, which may ease processing, but may prevent the intumescent material from being corrugated at ambient temperature.

Other additives known in the art may be utilized in the intumescent material. Some examples include colorants, oxidation stabilizers, UV stabilizers, reinforcing fibers, density reducing fillers (e.g., glass bubbles), processing aids (e.g., releasing agents), etc. Other additives are each typically present in the intumescent material in the amount of at least 0.1, 0.2, 0.5, or even 1 wt % and at most 3, 5, 8, or even 10 wt %, based on weight of the intumescent material.

The intumescent material reacts under the influence of heat to swell to many times its original thickness, producing an insulating char that protects a substrate to which the intumescent material is applied from the effects of fire. The ratio of swollen thickness to original thickness is called the expansion ratio. The intumescent material of the present invention beneficially has an expansion ratio of at least 10, 15, or even 20; and at most 40, 50, or even 60.

Metal Mesh

The intumescent composite material comprises at least one metal mesh layer. The mesh (i) may provide rigidity and shape memory to the intumescent material, and/or (ii) support the intumescent material following installation. It is generally desired that, while corrugating, the memory force of the intumescent materials to return to the original shape is less than the capacity of the metal meshes to retain the desired corrugated shape without significant deformation. For example, corrugating a 12 mm thick intumescent material may require a stronger mesh (larger diameter or smaller mesh size) compared to corrugating a 2 mm sheet. Further, commercial metal mesh is usually presented in a roll and non-flat form. When forming a composite intumescent structure, for example by pressing metal mesh and intumescent material together, an intermediate flat composite intumescent form can be achieved. It is generally desired that the memory force of the metal mesh to return to its originally presented non-flat shape is less than the capacity of the intumescent material to retain the flat shape. For example, for the same type and thickness of intumescent material, it is easier to maintain the composite intumescent structure in a flat form when using thin wire metal mesh as opposed to thick wire metal mesh. However, the metal meshes should still be strong enough to maintain the composite intumescent structure in the corrugated shape. A balance between the memory forces of the metal mesh and the intumescent material is desired.

Materials suitable for metal meshes include, for example, steels (iron), e.g., plain steel, galvanized steel, coated steel or stainless steel, and other generally strong, but formable materials with high melting points, such as nickel, copper, aluminum or suitable alloys. Meshes comprising materials such as fiberglass, plastics or carbon, for example, are generally unsuitable because these materials lack one or more of flexibility, shape retention and heat resistance, especially at wire thicknesses suitable for meshes in the present intumescent structures.

Meshes may be constructed of a crisscrossing array of metal strands, for example metal wires. Mesh size refers to the size of opening between the strands, e.g., the average distance between neighboring strands. Strand width refers to the diameter of each strand of the mesh. Mesh thickness refers to the thickness of the entire mesh. A balance of mesh size, strand width and mesh thickness may be important to provide sufficient support and rigidity for the corrugated intumescent composite while allowing the intumescent material to go through the openings when the material intumesces.

Mesh size and openings are important. If mesh openings are too small, intumescent materials may not be allowed to expand through the mesh during a fire, thus not providing the desired insulating function. Suitable mesh opening may also be used to control (e.g., depress) the expansion ratio and enhance the char density or strength, enabling longevity of the char during a fire. In one embodiment, the mesh size is at least 1.5, 1.6 mm, 1.8, 2.0, 2.5, 3.0, or even 3.2 mm (⅛ in); and at most 6.4, 10, 12.8, 20, or even 25.4 mm (1 in). In one embodiment, the strand width is at least 0.1 mm or even 0.5 mm; and at most than 0.8, or even 1 mm. In one embodiment, the mesh opening has a diameter of at least 1.5 or even 3.1 mm; and at most 10, 12, or even 13 mm. Relative weight of the metal meshes to the intumescent material is preferably in a range of at least 1, 2, 5, 10, or even 20% and at most 50, 60, 70, 80, 90 or even 100%.

The metal meshes may be woven but not welded, welded but not woven, or woven and welded. The use of welded meshes (woven or non-woven) may provide non-optimal results. Non-optimal results generally refer to a diminution in fireproofing performance or the aesthetic appeal of the composite intumescent structure. When using intumescent materials having high storage modulus, the use of welded meshes may result in broken mesh and/or cracked intumescent material. When using intumescent materials having low storage modulus, the use of welded meshes may result in the intumescent material squeezing through the mesh generating rough surfaces such as alligator skins. Corrugating composite intumescent structures with woven, but not welded mesh usually generates uniform and smooth corrugated shapes. Mesh breaking or materials cracking are generally not observed. Therefore, the metal meshes are preferably woven, more preferably woven and not welded.

The intumescent composite material of the present disclosure comprises a metal mesh layer in or on the intumescent material. This can be accomplished, for example, by coating the intumescent material onto a metal mesh or laminating a metal mesh onto/into a layer of intumescent material. In one embodiment, the intumescent structure may be produced by embedding the metal mesh into a sheet or film of the corrugated intumescent sheet material, or securing the metal mesh to a surface of the sheet of film. Where more than one metal mesh is used, the intumescent material may be disposed between two of the metal meshes. To accomplish embedding the metal mesh, the intumescent material may be heated to soften the intumescent material sufficiently so that the metal mesh may be pressed into the intumescent material. The intumescent material may then be cooled, and form a sandwich-like structure when at least two metal meshes are used. No spraying or coating is required. Preferably, mesh openings where the mesh is in contact with the intumescent material are fully occluded by the intumescent material, although not all of the mesh openings need to be fully occluded. The mesh may extend beyond the edges of the intumescent material, or the intumescent material may extend beyond the edges of the mesh, or the edges of the intumescent material and the mesh may meet.

In one embodiment, the intumescent composite is part of a multilayered article comprising a layer of the intumescent composite and at least one of a liner and/or a protective layer.

In one embodiment, the corrugated intumescent composite structure comprises an optional liner 12, which is used to protect the intumescent material during manufacturing, handling, and storage. For example, preventing scratching, contamination, and exposure to the environment (water or moisture, ultraviolet light, etc.), which can impact the integrity of the intumescent material. Such liners are typically removed either before installation or shortly thereafter (for example, within a day of installation). However, in one embodiment, the liner is not removed following installation and remains for the lifetime of the installation.

Exemplary liners are known in the art and can include a sheet or film made from paper (e.g., kraft paper), plastic, foam, metal (e.g., aluminum foil), and combinations thereof.

Polymeric liners include polyesters, polyolefins (e.g., polypropylene, such as mono-oriented polypropylene), polyvinyl chloride, polylactic acid, polyhydroxyalkanoate (PHA), and combinations thereof.

In one embodiment, the liner comprises an adhesive layer, which is used to adhere the liner to the intumescent composite material. Such adhesives are known in the art.

In one embodiment, the liner may comprise a release agent disposed on an outer polymeric layer, wherein the release agent contacts the intumescent composite material and aids in the removal of the liner from the intumescent composite material. These release agents may be especially useful in a paper-based liner. Such release agents are known in the art and include carbamates, urethanes, silicones, fluorocarbons, fluorosilicones, and combinations thereof.

In one embodiment, the multilayered article withstands weathering. For example, the liner is impermeable to water (such as rain and moisture), stable under exposure to ultra violet light and/or durable. For example, weather testing can include placing panels of the multilayered article in the outside environment angled at 45 degrees relative to the ground in certain locations (e.g., Florida, Arizona, and/or Ontario (Canada). The multilayered articles, comprising the intumescent composite material and the liner, with the liner facing outward, are exposed to the elements (e.g., rain, sun, wind, etc.) for up to 6 months. After 6 months of exposure, there is no damage, weight gain or loss of the multilayered article versus a multilayered article not exposed to weathering conditions and optionally, the liner can be removed from the multilayered article with no remnants of the liner remaining on the intumescent composite material following removal.

In one embodiment, the average thickness of the liner is at least 13 microns (0.5 mil), 15, 20, 50, or even 100 microns and at most 175, 200, 225, 250, or even 254 microns (10 mil).

In one embodiment, the corrugated intumescent composite structure comprises an optional polymeric layer 18. Such a polymeric layer is used as a moisture/water barrier to protect the intumescent composite materials during manufacturing, handling, and storage. In one embodiment, the polymeric layer may be identical to the liner. In another embodiment, the polymeric layer is different from the liner. Because after installation, the polymeric layer faces the metal decking, the polymeric layer may not need the same ultraviolet resistance requirements as the liner.

Exemplary polymeric layers can include polyesters, polyolefins (e.g., monoaxially oriented popylpropylene), polyvinyl chloride, polylactic acid resins, and combinations thereof.

In one embodiment, the polymeric layer has an average thickness of at least 13 microns (0.5 mil), 15, 20, 50, or even 100 microns and at most 175, 200, 225, 250, or even 254 microns (10 mil).

In one embodiment, the intumescent composite and/or the multilayered article is free of mineral wool. Mineral wool is known in the art and includes inorganic minerals such as silicon dioxide and other metal oxides such as aluminum oxide, calcium oxide, magnesium oxide, and/or iron oxide.

Shaping

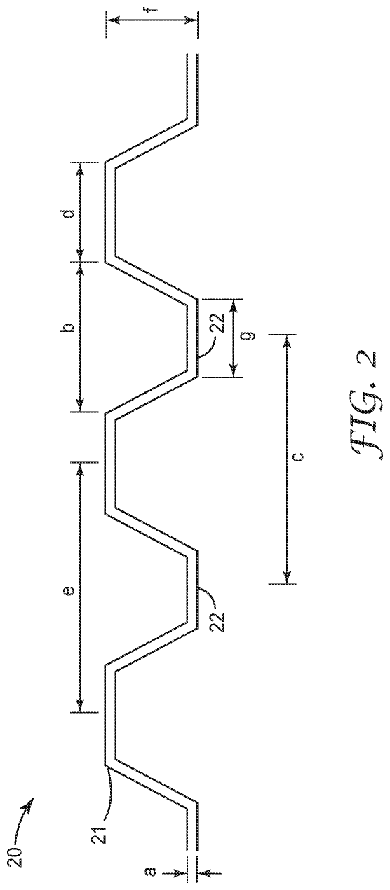

The corrugated intumescent composite structure of the present disclosure may be understood by reference to FIG. 2.

In the present disclosure, the intumescent composite material is configured into a corrugated structure having alternating ribs and flanges. An exemplary corrugated intumescent composite structure is shown in FIG. 2, where a is the thickness of the intumescent composite material. Corrugated intumescent composite structure 20, comprises a base with a plurality of ribs 22 extending therefrom. The rib has an opening of b with distance c between adjacent ribs (mid rib to adjacent mid-rib) and rib width g. Flange 21 has a width d with distance e between adjacent flanges (mid flange to adjacent mid flange). The height of the corrugated intumescent composite structure, f, is the distance from the top of the flange to the bottom of the rib.

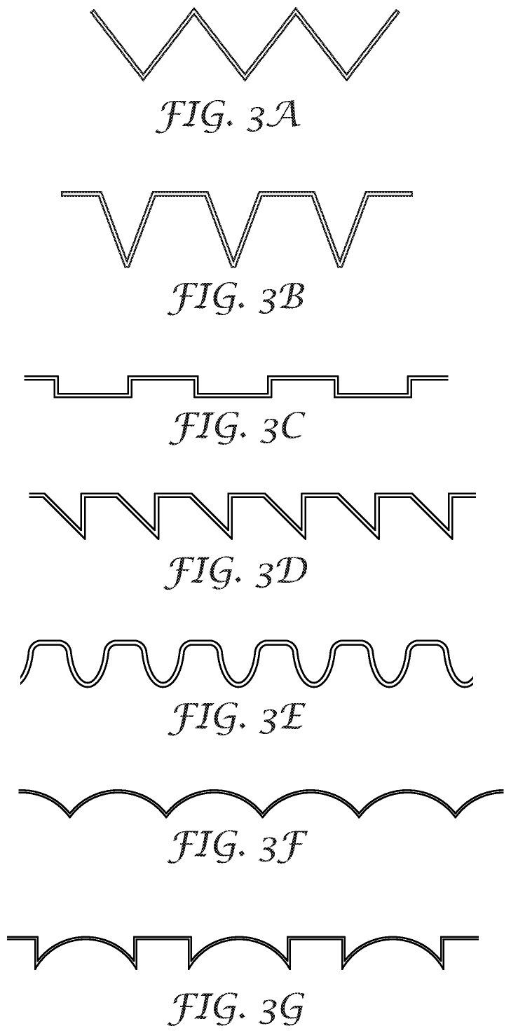

Alternative embodiments for the corrugated intumescent composite structure include those shown in FIGS. 3A to 3G. In FIG. 3A, the corrugated intumescent composite structure comprises ribs and flanges with substantially no width. In other words, the width of the rib or flange is no more than twice the thickness of the intumescent composite material a. In FIG. 3B, the corrugated intumescent composite structure comprises ribs with substantially no width, but flanges which have a measurable width. The sidewalls of the ribs may have a variety of shapes. The sidewalls of the ribs may be tapered as shown in FIG. 2, perpendicular to the base as shown in FIG. 3C, or a combination of tapered and perpendicular as shown in 3D. In one embodiment, the profiles of the corrugated intumescent composite structure may comprise curved segments such as those depicted in FIGS. 3E-3G.

In one embodiment, the flanges have an average width, d, of at least 0.25 mm (0.01 inch), 0.5, 1, 5, 10, 50, or even 100 mm; and at most 15, 20, 25, 28, or even 30.5 cm (12 inches). In another embodiment, the flanges do not have a substantial width, for example where the flange is represented by an angular point or an apex of a curve as shown in FIGS. 3A and 3F. The rib opening, b, has an average width of 0.25 mm (0.01 inch), 0.5, 1, 5, 10, 50, or even 100 mm; and at most 15, 20, 25, 28, or even 30.5 cm (12 inches). In one embodiment, the ribs have an average width g of at least 0.25 mm (0.01 inch), 0.5, 1, 5, 10, 50, or even 100 mm; and at most 15, 20, 25, 28, or even 30.5 cm (12 inches). In another embodiment, the ribs do not have a substantial width, for example where the rib is represented by an angular point or nadir as shown in FIGS. 3A, 3B, 3D, 3E, 3F, and 3G. In one embodiment, the height f of the corrugated intumescent composite material is at least of 2 mm (0.08 inch), 4, 6, 8, 10, 15, or even 20 mm; and at most 50, 60, 70, 80, 90, or even 102 mm (4 inch).

In one embodiment, the average width of the flanges and the ribs are the same (in other words, d=g).

In one embodiment, the thickness of the intumescent composite material, a, is at least 0.5, 0.6, or even 0.8 mm thick and at most 1.0, 1.2, 1.5, 2.0, 2.2, or even 2.5 mm thick.

The corrugated intumescent composite structure of the present disclosure comprises a plurality of flanges and ribs across the width of the structure, which extend down the length of the structure.

The corrugated composite structure may be in a roll or panel (sheet) format. The structure comprises a plurality of ribs extending from a base wherein the ribs are longitudinally parallel to one another and the ribs extend down the length of the roll or panel. In one embodiment, the corrugated intumescent composite structure comprises at least 2, 4, 6, 8, or even 10 ribs per roll or panel. In one embodiment, the corrugated intumescent composite structure comprises at least 2, 4 or 6 ribs per 2 feet (0.6 meter) across the width of the corrugated intumescent composite structure.

In one embodiment, the corrugated intumescent composite structure is a panel having a width of at least 30 cm (12 in), 50, or at least 70 cm; and at most 80, 100, 125, or even 130 cm (50 in) and a length of at least 30 cm (12 in), 50, or at least 80 cm; and at most 0.1, 0.5, 1, 1.5, 2, 2.5, or even 3 m (10 ft).

In one embodiment, the corrugated intumescent composite structure comprises extended tabs along the sides of the roll or panel, which can be used as a holding means to (i) overlap the panels at the flanges or ribs and/or (ii) attach the corrugated intumescent composite structure to the building structure.

The intumescent composite material can be shaped to form the corrugated structure using techniques known in the art, for example, by bending, pressing, twisting, roll forming, stamping, and other alterations. The configuration of the intumescent structure is thus made without breaking or unduly cracking the intumescent composite structure, especially without breaking or unduly cracking the intumescent material in the intumescent composite structure. The intumescent composite structure may have sufficient flexibility that bends or fold of up to 180° may be achieved without causing undue defects. The metal mesh combined with the intumescent material provides a balance between rigidity and flexibility so that the intumescent composite structure can be bent at low temperature to form a shape but still retain the bent shape after bending. The metal mesh helps protect the intumescent material from cracking during bending. In one embodiment, the metal mesh provides rigidity for shape retention where a flexible intumescent material would normally return to its original shape or at least lose a bent shape after being corrugated.

In one embodiment, the corrugated intumescent composite structure is made by first creating the intumescent composite material and then fabricating the composite material into a corrugated structure. In another embodiment, at least one metal mesh layer is fabricated into a corrugated structure and an intumescent material is applied thereon.

In the case of the former, the binder and resulting intumescent material preferably have physical properties that result in the intumescent composite material being bendable at a temperature above −10° C. Physical properties that result in the intumescent composite material being bendable at a temperature above −10° C. may be one or more of crystallinity index of the binder, glass transition temperature (T_{g}) of the binder, melting temperature (Tₘ) of the binder, storage modulus (G′) of the intumescent material, and elongation at break of the intumescent material. Where crystallinity of the binder is important, the binder is preferably semi-crystalline or amorphous. Semi-crystalline binders preferably have a crystallinity index above 0% but less than or equal to about 20%, more preferably about 10% or less. Amorphous binders have a crystallinity index of about 0%. Where T_{g} is important, the T_{g} is lower than the bending temperature, preferably at least about 25° C. lower than the temperature of bending. Where binder Tₘ is important, the Tₘ is preferably lower than the temperature of bending unless the crystallinity index is lower than 10%. Where storage modulus (G′) is important, the storage modulus of the intumescent materials is preferably in a range of 10⁶-10⁹ Pa at the temperature of bending. Where the elongation at break is important, the elongation at break is preferably larger than 15% at the temperature of bending.

In the case of corrugating the metal mesh and then applying the intumescent material, the metal mesh is corrugated using sheet metal bending equipment and methods, e.g., bending brakes, die sets, roll forming, etc. The intumescent material is applied thereon, for example by spraying, extruding, or disposing a conformable intumescent material thereof and pressing the metal mesh and the intumescent material together or securing the intumescent material onto the corrugated metal mesh.

In either case, bending the metal mesh first, versus bending the composite (metal mesh secured on or in the intumescent material), the corrugation can occur by bending by hand using a bending brake. This can be labour intensive and less reproducible regarding bending angles. In another embodiment, a mold can be used, wherein the metal mesh or composite is placed in a mold having the inverse of the desired pattern. The metal mesh or composite may be warmed prior to stamping. A press is then used to push the metal mesh or composite into the mold resulting in corrugation. Such a process may enable improved reproducibility.

The corrugated materials disclosed herein are self-supportive, meaning that when holding a panel (for example, a panel that is 6 ft (1.8 m) long by 2 ft (0.6 m) wide and 1 mm thick with the longitudinal axis of the ribs running lengthwise) on the two long ends, the deflection in the middle of the panel is less than 13, 10, 8, 6, 4, or even 2.5 cm (1 inch) from normal.

The corrugated intumescent structures disclosed herein can be used to protect metal decking within a building to prevent failure during a fire. Metal decking can be used to support floors and roofs in commercial buildings.

The objective of passive fire protection systems, is to limit and control the fire effects on structural steel in order to avoid or delay building collapse, which provides sufficient time for building evacuation and fire-fighting measures. Typically, metal decking is protected using spray applied fire resistive materials such as cementitious materials (for example gypsum-based formulations available under the trade designation “CAFCO” 300 series by Isolatek International, Stanhope, N.J.) and intumescent paint such as those available under the trade designation “ISOLATEK TYPE WB3”, “ISOLATEK TYPE WB4”, and “ISOLATEK TYPE WB5” from Isolatek International, which are applied directly to the metal decking. However, these sprays are not practical in unfavorable weather conditions, and in projects with limited access ability. In those cases, rigid board, such as mineral fiber board, is used. However, the rigid board can be difficult to handle due to its bulky nature, and is typically one to two inches thick, which can occupy space in a building.

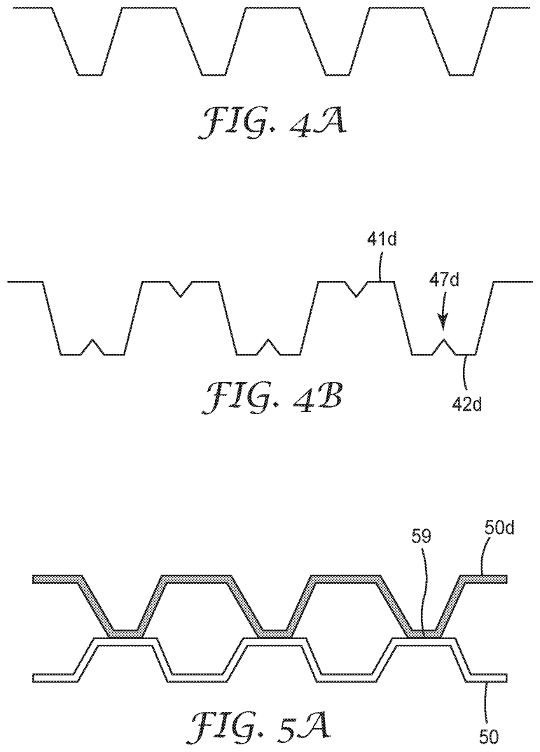

Metal decking is typically corrugated. Exemplary embodiments of such metal decking are shown in FIGS. 4A and 4B. FIG. 4A shows an unincorporated metal decking comprising a plurality of flanges and ribs. FIG. 4B is an incorporated metal decking comprising flange 41d, and rib 42d. Indentions in the flange and rib, such as indention 47d in rib 42d, are said to assist in bonding with the subsequently added concrete. Similar terminology as used for the corrugated intumescent composite structure in FIG. 2 can be used to describe the metal decking. For example, the rib has an opening of b and rib width g. Flange has a width d. The height of the metal decking, f, is the distance from the top of the flange to the bottom of the rib.

The thickness of the metal decking material, a, also known as gauge, is typically at least 0.8, 0.9, or even 1.0 mm and at most 1.1, 1.2, or even 1.3 mm.

The flange of the metal decking is formed with two longitudinal upwardly projecting ribs separated by a solid land section through which shear stud connectors can be positioned. In one embodiment, the average width of the rib, g, is at least 3.8 cm (1.5 inches), 5, 8, or even 10 cm; and at most 15, 20, 25, or even 30.5 cm (12 inches). As will be described more below, typically, the flange of the corrugated intumescent composite structure is fastened to the rib of metal decking. In the instance where the metal decking is interlocking, as shown by indentation 47, the mechanical fastener (such as a nail) may be positioned slightly away from the indentation, but still on the rib portion of the metal decking to attach the metal decking to the corrugated intumescent composite structure. In one embodiment, the mechanical fastener may be positioned directly over the indentation, essentially flattening the indention along the rib.

In one embodiment, the metal decking is manufactured from steel. In one embodiment, the metal decking is manufactured from galvanized steel. Commercial metal decking is available from multiple manufactures such as Canam, Quebec, ON, Canada (products such as P-3615, P-3606, P-2432, and P-2432), Vicwest, Winnipeg, MB, Canada (products such as FD3-6, FD308, FD938, HB938-ZF75, HB938-Z275, HBD938-INV-Z275, and HB938-INV-ZF75), Samuel Roll Form Group, Mississuaga, ON, Canada (products such as S-300-K, and 5-15-K), Ideal Roofing Co., Ottawa, Canada (products such as ICD-150/ICD-151, ICD-150/ICD-151 Inverted, IRD-300/IRD-301, and ICD-300/ICD-301 Inverted), Agway Metals, Inc., Brampton, ON, Canada (products such as CD36/CD36 CL, CD36/CD36 CL Inverted, CD75-150/CD75-150 CL, CD75-150/CD75-150 CL Inverted, CD75-200/CD75-200 CL, CD75-200/CD75-200 CL Inverted, and CD75-300/CD75-300 CL), and Brown-Campbell Co., Minneapolis, Minn., USA (1½ inch Not Interlocking composite floor deck, 2 inch Interlocking composite floor deck, 3 inch Interlocking composite floor deck).

In the present disclosure, the corrugated intumescent composite structure disclosed herein is disposed onto the underside of the metal decking relative to the ground. It is advantageous for the flange of the corrugated intumescent composite structure to be disposed onto the rib of the metal decking.

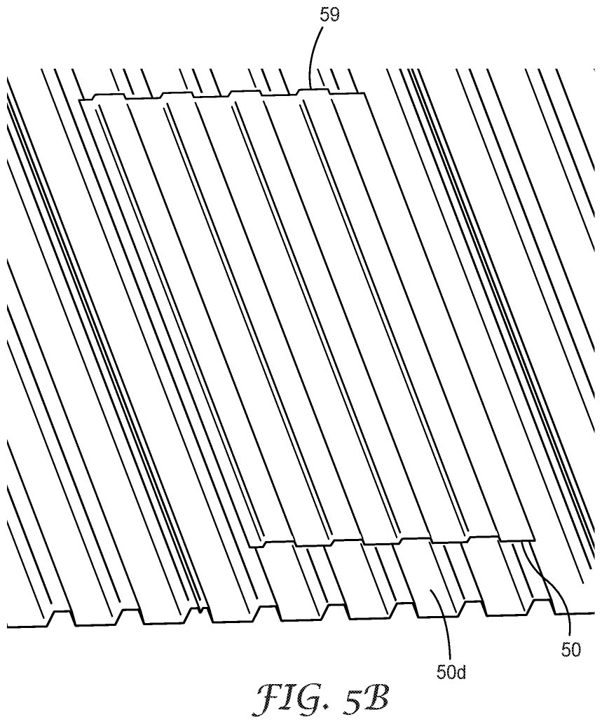

FIGS. 5A and 5B show the overlaying of the corrugated intumescent composite structure with a corrugated metal decking, wherein the plurality of flanges and ribs run parallel with one another. FIG. 5A depicts a cross sectional view of an exemplary assembly of the present disclosure, wherein corrugated intumescent composite material 50 is disposed onto corrugated metal decking 50d. As shown in FIG. 5A, the rib of the corrugated metal decking contacts or is in close proximity to the flange of the corrugated intumescent composite structure at position 59. The corrugated intumescent composite structure may be physically attached to the corrugated metal decking at position 59. Shown in FIG. 5B is a perspective view of the corrugated intumescent composite structure 50 disposed onto the corrugated metal decking 50d. As shown in this perspective, the plurality of ribs and flanges of the corrugated metal decking are parallel to the ribs and flanges of the corrugated intumescent composite structure with the rib of the metal decking disposed on the flange of the corrugated intumescent composite structure at position 59. As shown in FIG. 5A, the corrugated intumescent composite structure is off-set, such that the flanges of the corrugated intumescent composite structure contact or are in close proximity to the ribs of the metal decking.

Although FIGS. 5a and 5b depict the periodicity (frequency of the flanges/ribs) of the metal decking and the corrugated intumescent composite structure to be the same, wherein each rib of the metal decking contacts or is in close proximity to each flange of the corrugated intumescent composite structure, various other embodiments can be envisioned, when the longitudinal direction of the ribs of the metal decking and the corrugated intumescent composite structure are the same. For example, the periodicity of the metal decking and the corrugated intumescent composite structure may be different, wherein a flange of the corrugated intumescent composite structure is in contact or close proximity to two ribs of the metal decking; or wherein a rib of the metal decking is in contact or close proximity to two flanges of the corrugated intumescent composite. In another embodiment, the periodicity is such that a rib of the metal decking contacts or is in close proximity to a flange of the corrugated intumescent composite structure only twice along the width of the corrugated intumescent composite structured panel.

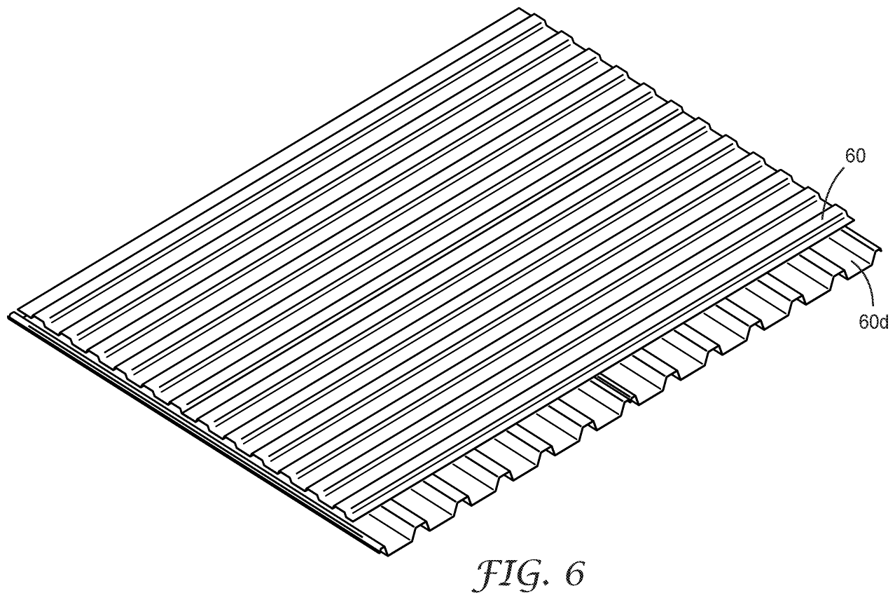

FIG. 6 depicts another embodiment of the corrugated intumescent composite structure corrugated metal decking assembly, wherein the plurality of flanges and ribs of the corrugated intumescent composite structure are perpendicular to the ribs and flanges of the corrugated metal decking. As shown in FIG. 6, the corrugated intumescent composite structure 60 is disposed onto the corrugated metal decking 60d. Also shown in FIG. 6 is the overlapping of two decking panels. The ends of the corrugated intumescent composite structures may be overlapped in a similar manner.

Besides, the configurations depicted in FIGS. 5A and 5B and 6, other configurations may be envisioned, for example wherein an axial line running parallel with the plurality of flanges and ribs of the corrugated intumescent composite structure is at least 0, 5, 10, 15, 20, 25, or even 30 degrees and at most 50, 60, 70, 80, or even 90 degrees from an axial line running parallel with the ribs and flanges of the corrugated metal decking.

If panels of the corrugated intumescent composite structures are used, there should be overlap between the various panel to maintain good fire protection of the metal decking. The seams (side-to-side and/or end-to-end) of the adjacent panels should overlap by at least 0.6 cm (0.25 in), or even 2.5 cm (1 inch); and at most 5.1, 7.6, 12, or even 15 cm (2, 3, 5, or even 6 inches) and fastened into place.

In one embodiment, the corrugated intumescent composite structures comprise a holding means at the edge of the panel running parallel to the length of the ribs. In one embodiment, the holding means is the flange. In another embodiment, additional intumescent composite material is left along the edge to serve as a holding means for handling and attachment to the metal decking.

In another embodiment, a rib along the edge of a first panel is overlapped with a rib along the edge of a second panel and then fastened together to create a fire protected seam.

Although not wanting to be limited by theory, it is believed that air located between the metal decking and the corrugated intumescent composite material acts as a thermal barrier helping to minimize the temperatures experienced by the metal decking.

The corrugated intumescent composite structure may be attached to the corrugated metal decking using any suitable manner, for example with the use of a mechanical fastener. Mechanical fasteners include, for example, bolts, clamps, staples, screws, pins, grips, tack strips and magnets. Typically, a mechanical fastener will be used to connect the flange of the corrugated intumescent composite structure to the rib of the corrugated metal decking.

Surprisingly, it has been discovered that by applying a corrugated intumescent composite structure onto the metal decking results in an easy to install, self-supportive structure that can provide protection to a metal decking allowing it to withstand fire conditions for a given amount of time without failure.

The corrugated intumescent composite structure may be applied to the corrugated metal decking to protect the metal decking in the case of a fire. In other words, the corrugated intumescent material is situated between the fire and the metal decking. The assembly (i.e., the metal decking and the corrugated intumescent composite structure) can, for a period of time, withstand the heat intensity (under conditions of a fire) and not structurally fail or allow the cold side of the assembly to become hotter than a given temperature (e.g., about 250° F. (121° C.) above ambient).

In one embodiment, the assembly passes an approved regiment of testing. Such tests include: ASTM method E119-18c “Standard Test Method for Fire Tests of Building Construction Materials”; and the UL (Underwriters Laboratory) standard 263-14 “Standard for Fire Tests of Building Construction and Materials”. UL 263 is similar to the temperature profile of ASTM 119D. Other tests include: CAN/ULC-S101-14 “Standard Methods of Fire Endurance Tests of Building Construction and Materials” 5^{th} edition.

To achieve a desired rating, the assemblies of the present disclosure need to withstand a defined temperature profile for a period of time (as described in the standards). The assembly is then rated based on the outcome of the tests. For example, if there are no failures at 2 hours following the test methods, the assembly is then rated for 2-hour. In one embodiment, the assembly of the present disclosure (i.e., corrugated intumescent composite structure and metal decking) withstands the approved regiment of testing for a period of at least 30 minutes, at least 1 hour, at least 2 hours, or even at least 4 hours, in accordance with standard methods of fire endurance tests of building construction (CAN/ULC S101, ASTM 119).

Exemplary embodiments of the present disclosure, include, but are not limited to, the following:

Embodiment 1. A corrugated intumescent composite structure, the composite structure comprising at least one metal mesh layer secured on or in an intumescent material, wherein the composite structure comprises a plurality of alternating flanges and ribs.

Embodiment 2. The composite structure of embodiment 1, wherein the average width of a flange in the plurality of flanges is at least 2.5 cm and at most 30.5 cm.

Embodiment 3. The composite structure of any one of the previous embodiments, wherein the distance between adjacent ribs is at least 5 cm and at most 31 cm.

Embodiment 4. The composite structure of any one of the previous embodiments, wherein the height of the corrugated intumescent composite structure is at least 0.2 cm and at most 5.1 cm.

Embodiment 5. The composite structure of any one of the previous embodiments, wherein the ribs have tapered sidewalls.

Embodiment 6. The composite structure of any one of the previous embodiments, wherein corrugated intumescent composite structure has a thickness of at least 0.5 mm and at most 2.5 mm.

Embodiment 7. The composite structure of any one of the previous embodiments, wherein the at least one metal mesh has a mesh size of 1.5 mm or greater.

Embodiment 8. The composite structure of any one of the previous embodiments, wherein the at least one metal mesh comprises steel.

Embodiment 9. The composite structure of any one of the previous embodiments, wherein the at least one metal mesh is not welded.

Embodiment 10. The composite structure of any one of the previous embodiments, wherein the intumescent material comprises: (i) 15 wt % or more of a polymeric binder based on total weight of the intumescent material; (ii) a filler; and (iii) an intumescent component.

Embodiment 11. The composite structure of embodiment 10, wherein the polymeric binder has a crystallinity index of 20% or less.

Embodiment 12. The composite structure of embodiment 10, wherein the polymeric binder is amorphous.

Embodiment 13. The composite structure of embodiment 10, wherein the polymeric binder is semi-crystalline and has a crystallinity index of 10% or less.

Embodiment 14. The composite structure of any one of embodiments 10-13, wherein the intumescent component is phosphate-based.

Embodiment 15. The composite structure of any one of embodiments 10-14, wherein the polymeric binder comprises an ethylene-vinyl acetate copolymer.

Embodiment 16. The composite structure of embodiment 15, wherein the ethylene-vinyl acetate copolymer has a vinyl acetate content of 40 wt % or more based on total weight of the copolymer.

Embodiment 17. The composite structure of any one of the previous embodiments, wherein the intumescent material has an expansion ratio in a range of 10-60.

Embodiment 18. A method of protecting corrugated metal decking comprising attaching the composite structure of any one of the previous embodiments, wherein the corrugated metal decking comprises a plurality of alternating flanges and ribs.

Embodiment 19. The method of embodiment 18, wherein at least one of the plurality of ribs of the corrugated metal decking is fastened to at least one of the plurality of flanges of the composite structure.

Embodiment 20. The method of any one of embodiments 18-19, wherein the composite structure is attached to the corrugated metal decking with a mechanical fastener.

Embodiment 21. The method of embodiment 20, wherein the mechanical fastener is selected from a nail, a screw, a staple, clamp, or combinations thereof.

Embodiment 22. The method of any one of embodiments 18-21, wherein the plurality of alternating flanges and ribs of the metal decking are parallel to the plurality of alternating flanges and ribs of the composite structure.

Embodiment 23. The method of any one of embodiments 18-22, wherein the longitudinal axis of a rib in the plurality of ribs of the metal decking is not parallel to the longitudinal axis of a flange in the plurality of flanges of the composite structure.

Embodiment 24. The method of embodiment 23, wherein the longitudinal axis of a rib in the plurality of ribs of the metal decking is perpendicular to the longitudinal axis of a flange in the plurality of flanges of the composite structure.

Embodiment 25. The method of any one of embodiments 18-24, wherein the metal decking is interlocking.

Embodiment 26. The method of any one of embodiments 18-25, wherein the seams of the composite structure overlap by at least 0.6 cm and at most 5.1 cm.

Embodiment 27. The method of any one of embodiments 18-26, wherein the metal decking comprises 2 to 8 ribs per 0.6 meters.

Embodiment 28. The method of any one of embodiments 18-27, wherein the height of the flange of the metal decking is at least 1 cm and at most 10.2 cm.

Embodiment 29. The method of any one of embodiments 18-28, wherein the plurality of ribs of the metal decking have tapered sidewalls.

Embodiment 30. The method of any one of embodiments 18-29, wherein the plurality of ribs of the metal decking have perpendicular sidewalls.

Embodiment 31. The method of any one of embodiments 18-30, wherein the composite structure fastened to the metal decking passes ASTM E119 2 hour test with a 6.3 cm (2.5 inch) thick concrete.

### EXAMPLES

Unless otherwise noted, all parts, percentages, ratios, etc. in the examples and the rest of the specification are by weight, and all reagents used in the examples were obtained, or are available, from general chemical suppliers such as, for example, MilliporeSigma Company, Burlington, Mass., unless otherwise noted. The following abbreviations are used herein: gm=grams; mm=millimeter; cm=centimeters; in =inch; ft=foot; sq. ft.=square foot; min=minute; sec=second; psi=pounds per square inch; MPa=megapascals; RPM=revolutions per minute; ° F.=degrees Fahrenheit; ° C.=degrees centigrade. The terms wt %, and % by weight are used interchangeably.

TABLE 1

| Abbreviation | Description and Source |
|---|---|
| AP422 | Ammonium polyphosphate, charring catalyst, obtained under the trade |
| | designation “EXOLIT AP422” from Clariant Company; Knapsack, Germany |
| PM40 | Pentaerythritol, charring agent, obtained under the trade designation |
| | “CHARMOR PM40” from Perstorp Chemicals GmbH, Arnsberg, Germany |
| TiO2 | Titanium dioxide, inorganic filler obtained under the trade designation “TI- |
| | PURE R706” from E.I. du Pont de Nemours and Company; Wilmington, DE |
| ZnSt | Zinc stearate 201 obtained from Blachford Corp., Frankfort, IL |
| Melamine | Melamine, blowing agent, Melamine Grade 003, obtained from DSM |
| | Melamine Americas, Inc.; Westwego, LA |
| EVA | Ethylene-vinyl acetate co-polymers, binder, obtained under the trade |
| | designation “LEVAMELT 456” from Lanxess Corp., Pittsburgh, PA |
| Mesh | Stainless steel mesh, woven but not welded, 3.18 mm mesh size and 0.43 mm |
| | wire diameter, obtained from Gerald Daniel Worldwide, Inc.; Hanover, PA |
| MOPP Film | A blue 3.3 mils (84 microns) tensilized T2S monoaxially oriented |
| | polypropylene (MOPP) film, obtained from Nowofol, Siegsdorf, Germany |
| PP Film | Polypropylene film, having a thickness of 3.3 mils (84 microns) which may be |
| | obtained from Sigma Plastic, Gray Court, SC |

Preparation of Intumescent Material:

42.6 gm of AP422, 15.3 gm of PM40, 12.3 gm of Melamine, 12.3 gm of TiO2 and 16.8 gm of EVA and 0.8 gm of ZnSt were compounded using a Brabender mixer at a batch size of 300 gm, temperature of 100-150° C., 60 RPM for 4-5 min to form a compounded intumescent material.

Expansion Ratio Test:

The compounded intumescent material was then pressed into a sheet that was 100 mm (3.9370 in) wide×100 mm (3.9370 in) long×2 mm (0.0787 in) thick. The expansion ratio of this sheet was 37. The expansion ratio was obtained by exposing the sheet in a muffle furnace at 500° C. for 30 min. After cooling, the average thickness of the heated sheet (based on five different points along the thickness of the sheet) was measured and the expansion ratio was calculated by dividing the average thickness of the heated sheet by the average thickness of the sheet before heating.

Intumescent Material Sheet Forming:

The compounded intumescent material was then pressed at 105-110° C. to the desired sheet thickness of using a Carver or Wabash hot press machine to form an intumescent material sheet.

Forming of Intumescent Composite Sheet:

The intumescent composite sheet was formed by stacking the following layers in order: PP Film, intumescent sheet material, Mesh, and MOPP Film between two hot plates, pressed at 90° C. for 1 min at 400 psi (2.758 MPa).

Corrugation of the Intumescent Composite Structure:

A 25 in (63.5 cm) wide and 72 in (183 cm) long sheet of Intumescent Composite material was marked on one side of the sheet designating bend lines to form the flanges and ribs of the corrugated structure. Hand bending was used to form the corrugation. Bending began as close to the center of the sheet as possible (bending brake supports dictated how far in material could be fed). Bends were made as marked. After every other bend, it was required to flip the sheet end over end so that the next two bends could be made in the opposite direction. This created the desired corrugated profile.

A 6 rib design was made across the width of the sheet, starting with a 1 in (2.5 cm) tab followed by 6 rib-flange pairs. The sheet had the following dimensions referring to FIG. 2: b=2.0 in (5.1 cm); d=2.0 in (5.1 cm); f=0.5 in (1.3 cm); and g=1.5 in (3.8 cm).

The corrugated intumescent composite structure (CICS) was 24 in (609.6 mm) across from flange to end of last rib. There was approximately a 1 in (25.4 mm) flange portion after the last rib to enable overlap of the corrugated structures and to secure the corrugated structure onto the metal decking.

Preparing Assembly

Steel decking, 50 in (127 cm)×72 in (183 cm) having a 2 in (5 cm) depth, obtained from Total Construction & Equipment (Inner Grove Height, Minn.) was used. Normal concrete was poured onto the top of the steel decking such that a 2.5 in (64 mm)-thick layer of concrete was above of the metal decking.

Prior to the installation, the MOPP film was removed from the CICS. The CICS was installed with flange side (PP film side) contacting the steel deck ribs. 2 pieces of 8 in (20 cm) the CICS were used to cover the underside of the steel decking. The CICS was installed such that the ribs and flanges of the CICS were perpendicular to the ribs and flanges of the steel deck. There was a 0.5 in (1.3 cm) overlap between each of CICS joints. The CICS was disposed onto the metal decking such that each 8 in (20.3 cm)×24 in (60.9 cm) panel overlapped the adjacent CICS panel in such a way that the pattern continued in a consistent manner.

Galvanized nails (0.5 in (13 mm), zinc-plated, collated, steel pins from Senco Brands, Inc., Cincinnati, Ohio, USA) and pneumatic concrete pinner SCP40XP nail gun (from Senco Brands, Inc.) were used to fasten the CICS to the steel decking at about 1 nail/per sq. ft (0.093 m²), such that the nails were fastened to where the flanges of the CICS contacted the ribs of the metal decking.

Fire Test:

The assembly as described above was placed on top of a floor furnace with the CICS facing the toward the fire. Thermocouples were placed on the concrete side of the assembly, and then insulated with a mineral blanket. The test was conducted following ASTM E119-18c. The temperature at the concrete surface was recorded during the fire test. The time that it took from the start of the test to the moment that the concrete surface temperature reached 250° F. (121° C.) plus ambient air temperature was recorded as the fire resistant time of the CICS protected floor deck.

### EXAMPLES

In Example 1, the CICS was 1.1 mm thick (represented as “a” in FIG. 2), with 0.9 mm thick of intumescent material. The CICS was corrugated with 6 ribs per 2 feet (61 cm). The CICS was disposed onto a metal decking forming an assembly as described above and the assembly was Fire Tested. Example 1 has a fire resistance time of 130 min.

In Example 2, the corrugated intumescent composite structure was 1.2 mm thick (represented as “a” in FIG. 2), with 1 mm thick of intumescent material. The CICS was corrugated with 6 ribs per 2 feet (61 cm). The CICS was disposed onto a metal decking forming an assembly as described above and the assembly was Fire Tested. Example 2 has a fire resistance time of greater than 140 min.

Foreseeable modifications and alterations of this invention will be apparent to those skilled in the art without departing from the scope and spirit of this invention. This invention should not be restricted to the embodiments that are set forth in this application for illustrative purposes. To the extent that there is any conflict or discrepancy between this specification as written and the disclosure in any document mentioned or incorporated by reference herein, this specification as written will prevail.

1.-10. (canceled)

11. A method of protecting corrugated metal decking comprising attaching a composite, wherein the composite structure comprises at least one metal mesh layer secured on or in an intumescent material, and wherein the composite structure comprises a plurality of alternating flanges and ribs, and wherein the corrugated metal decking comprises a plurality of alternating flanges and ribs.

12. The method of claim 11, wherein at least one of the plurality of ribs of the corrugated metal decking is fastened to at least one of the plurality of flanges of the composite structure.

13. The method of claim 11, wherein the composite structure is attached to the corrugated metal decking with a mechanical fastener.

14. The method of claim 11, wherein the plurality of alternating flanges and ribs of the metal decking are parallel to the plurality of alternating flanges and ribs of the composite structure.

15. The method of claim 11, wherein the longitudinal axis of a rib in the plurality of ribs of the metal decking is not parallel to the longitudinal axis of a flange in the plurality of flanges of the composite structure.

16. The method of claim 11, wherein the average width of a flange in the plurality of flanges is at least 2.5 cm and at most 30.5 cm.

17. The method of claim 11, wherein corrugated intumescent composite structure has a thickness of at least 0.5 mm and at most 2.5 mm

18. The method of claim 11, wherein the height of the corrugated intumescent composite structure is at least 0.2 cm and at most 5.1 cm.

19. The method of claim 11, wherein the at least one metal mesh has a mesh size of 1.5 mm or greater.

20. The method of claim 11, wherein the intumescent material comprises: (i) 15 wt % or more of a polymeric binder based on total weight of the intumescent material; (ii) a filler; and (iii) an intumescent component.

21. A corrugated intumescent composite structure, the composite structure comprising at least one metal mesh layer secured on or in an intumescent material, wherein the composite structure comprises a plurality of alternating flanges and ribs.

22. The composite structure of claim 21, wherein the average width of a flange in the plurality of flanges is at least 2.5 cm and at most 30.5 cm.

23. The composite structure of claim 21, wherein the distance between adjacent ribs is at least 5 cm and at most 31 cm.

24. The composite structure of claim 21, wherein the height of the corrugated intumescent composite structure is at least 0.2 cm and at most 5.1 cm.

25. The composite structure of claim 21, wherein the ribs have tapered sidewalls.

26. The composite structure of claim 21, wherein corrugated intumescent composite structure has a thickness of at least 0.5 mm and at most 2.5 mm.

27. The composite structure of claim 21, wherein the at least one metal mesh has a mesh size of 1.5 mm or greater.

28. The composite structure of claim 21, wherein the intumescent material comprises: (i) 15 wt % or more of a polymeric binder based on total weight of the intumescent material; (ii) a filler; and (iii) an intumescent component.

29. The composite structure of claim 28, wherein the intumescent component is phosphate-based.

30. The composite structure of claim 28, wherein the polymeric binder comprises an ethylene-vinyl acetate copolymer.
